(19) United States
(12) Patent Application Publication
(10) Pub. No.: US 2007/0266613 A1
(43) Pub. Date: Nov. 22, 2007

(54) Decoy portions and decoys comprising rigid polyurethane, and related methods

(76) Inventor: Barry J. Nelson, Spicer, MN (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 11/437,961

(22) Filed: May 19, 2006

(51) Int. Cl. A01M 31/06

(52) U.S. Cl. 43/3

(57) ABSTRACT

Described are game decoys and methods of preparing game decoys, the decoys including at least a portion that includes a rigid polyurethane, the methods and decoys can exhibit properties such as durability and resistance to mechanical damage, and may exhibit specific measured properties selected from elongation, hardness, and specific gravity, to achieve such mechanical properties.

### FIELD OF THE INVENTION

The invention relates to wildlife decoys and in particular to decoys prepared from rigid polyurethane and materials of similar mechanical properties. Preferred rigid polyurethane materials can be derived from liquid materials that contain reactive isocyanate and polyol (e.g., monomers, pre-polymers, polymers, etc.) and that can be molded or otherwise formed into a shape of a decoy or a portion of a decoy. Preferred liquid polymeric materials may be high solids (e.g., 100 percent solids), may be cured or crosslinked, and may contain particulate filler such as ceramic particles. The decoys, comprising cured rigid polyurethane, exhibit properties of high strength, toughness, resistance to gunshot, and durability.

### BACKGROUND

For hunters who use decoys to attract game, durability of a decoy is essential. Decoys are often handled aggressively by throwing onto a field, into a pickup bed or storage area of a sport-utility vehicle or car, into a bag containing other decoys, or by being accidentally hit by shotgun fire. This aggressive handling can cause the decoys to be structurally broken resulting in lost body parts such as a bill, head, neck, or tail, or a loss of buoyancy. The cost of decoys can be significant, up to and exceeding several hundred dollars per dozen. Hunters wish to avoid damage to decoys to avoid replacement costs. Also important is that upon arriving at a hunting location a hunter does not want to find that decoys have become broken and unusable. It is inconvenient to repair decoys in the field. For floating decoys, durability is important to avoid having decoys lose buoyancy and sinking and becoming lost, e.g., if accidentally damaged or shot during use. For field decoys, a decoy that is shot may no longer mimic the game being attracted due to loss of body parts such as a head, tail, or neck.

Currently, various types of decoys are available, including foam, cork, wood, and plastic decoys. These can exhibit various deficiencies in durability properties. In particular, decoys of foam and cork can be easily broken, especially at extended body portions such as the bill, head, neck, and tail. If broken a head may be replaced, but this can be expensive and time consuming, and a more durable decoy that would not break in the first place would be preferred over a decoy that could be fixed if broken. Many plastic decoys are hollow and can easily lose buoyancy upon being damaged.

### SUMMARY

The invention relates to game decoys that include at least a portion of the decoy that is constructed of a rigid polyurethane.

A rigid polyurethane is a type of polyurethane material known in the arts of polyurethanes and polymeric materials. The term is used herein in a manner consistent with the normal meaning in the polyurethane arts. Exemplary rigid polyurethane materials include materials in the class of polyurethane materials, typically a rigid polyurethane foam, that exhibit high strength, high modulus, and high dimensional stability. Exemplary rigid polyurethanes for use according to the invention exhibit mechanical properties as described herein, and may be characterized chemically as a crosslinked polyurethane foam optionally having closed cells, made by reacting a diisocyanate such as diphenylmethane-4,4′-diisocyanate (MDI), polymeric MDI, or diphenylmethane diisocyanate, with a polyol, especially a polyether polyol (e.g., polyether triol), or a polyester.

Exemplary rigid polyurethane materials can be derived from an isocyanate material such as an isocyanate monomer, polymer, or pre-polymer, and may be formed into a decoy (i.e., an entire decoy head, body, and optional ballast, etc.) or decoy portion (e.g., head, body, or other portion of a complete decoy) by any method, such as by molding a liquid precursor to a cured, rigid polyurethane. Exemplary liquid precursors may be high solids (e.g., 100 percent solids), can be derived from an isocyanate material, and may most preferably be molded to form a hollow decoy portion that exhibits mechanical properties including high strength, toughness, and durability.

Decoys of the invention may be for fowl such as waterfowl, including geese or ducks, or may be for turkey, or for any other land, field, lake, sea, or other game or non-game animal as desired. The decoy may be buoyant and for use in water such as with a duck or a goose decoy, or may be for use on land, such as with goose and turkey decoys. The decoy may be assembled from multiple pieces or parts of cork, wood, or foam, often from parts that include one or more separate body pieces, a headpiece, any one or more of which may be made of rigid polyurethane.

A decoy portion that is made of a molded rigid polyurethane can exhibit a very high level of detail from the mold. For example, a mold may be made to include a high level of detail of feathers, beak or bill features, an eye, etc., and these details can transfer to a molded decoy portion made of molded rigid polyurethane.

According to one aspect, the invention relates to a game decoy comprising a decoy body mimicking a shape of a game animal, the decoy comprising rigid polyurethane. The polyurethane has been shown to exhibit very useful mechanical properties for game decoys. The polyurethane can be in the form of a shell of a thickness of, for example, 0.25 to 0.5 inches, and may be backed by a buoyant material such as a foam, cork, wood, etc.

In another aspect, the invention relates to a method of preparing a game decoy or a portion of a game decoy. The method includes: providing a mold of a decoy or decoy portion, providing a liquid composition capable of hardening to rigid polyurethane, pouring the liquid composition into the mold, and allowing the liquid composition to cure to a rigid polyurethane.

### BRIEF DESCRIPTION OF THE DRAWINGS

FIG. 1 is a side cut-away view of a decoy (complete decoy) of the invention.

FIG. 2 is a side cut-away view of a decoy portion (i.e., decoy head) of the invention.

FIG. 3 is a side cut-away view of a decoy of the invention comprising a decoy head attached to a decoy body portion.

All drawings are schematic and not to scale, and are not intended to limit the invention.

### DETAILED DESCRIPTION

Rigid polyurethane materials are known in the polymer and materials arts, and have various industrial uses.

According to the invention, rigid polyurethane materials have been found to be useful for constructing decoys and decoy parts. Useful rigid polyurethane materials can exhibit specific mechanical properties including one or more of the following, alone or in any combination:

| | |
|---|---|
| elongation (ASTM D 638) | less than 2 percent, e.g., from 0.5 to |
| | 1.5 percent, |
| Shore D hardness (ASTM D 638) | from 50 to 70, e.g., from about 55 to |
| | about 65, |
| Tensile strength (ASTM D 638) | 2500 to 4000 pounds per square |
| | inch; and |
| specific gravity (i.e., the ratio of | from 0.5 to 0.9. |
| the density of the rigid poly- | |
| urethane to the density of water) | |

Polyurethanes generally are materials made from reactive ingredients that include an isocyanate compound (e.g., monomers, oligomers, pre-polymers, polymers, etc.) containing multiple isocyanate (NCO-) moieties (a “polyisocyanate” compound), e.g., two isocyanate moieties, which compound is referred to as a diisocyanate, reacted with an active-hydrogen-containing compound. The reaction can occur through the use of a one-part or a two-part composition, and if desired by forming a prepolymer before reacting the components to form a polyurethane.

An isocyanate can be combined and react with a material that includes one or multiple reactive hydrogens, such as a compound (e.g., monomer, oligomer, pre-polymer, polymer, etc.) that includes one or multiple alcohol or amine moieties, e.g., a polyol or a poly-amine-functional compound such as a diamine. The reaction is a condensation reaction between the polyisocyanate and the active-hydrogen-containing compound. Optionally and desirably, the condensation reaction can also result in crosslinking between polymers.

For purposes of this description, polyurethanes include polyureas, which include reaction products of a polyisocyanate reacted with a multi-amine-functional compound. Exemplary polyureas are prepared by reacting a diisocyanate (e.g., MDI) with amine-terminated polyethers.

An isocyanate compound may be a low or very low molecular weight compound or higher molecular weight prepolymer or polymer. The compound or backbone of an oligomer, polymer, or prepolymer may be of any desired chemistry, such as aliphatic, aromatic, polyether, etc. Examples of a diisocyanates useful to prepare polyurethane materials include methylene-4,4′-dipyenyl diisocyanate (MDI) and diphenylmethane diisocyanate.

A polyol or poly-functional amine compound may be a low or very low molecular weight compound or higher molecular weight prepolymer or polymer. The base compound or backbone of an oligomer, polymer, or prepolymer may be of any desired chemistry, such as aliphatic, aromatic, polyether, etc. Exemplary polyols include polyether polyols, e.g., polyether triols. Exemplary poly-functional amine compounds include aromatic diamines.

Exemplary rigid polyurethane materials can be closed-cell, crosslinked polyurethane foams prepared by reacting an isocyanate (e.g., a diisocyanate, and frequently diphenylmethane-4,4′-diisocyanate (MDI) or polymeric MDI) with a polyether polyol (e.g., a triol such as a polyether triol), or a polyester.

A rigid polyurethane material may include inert filler such as particulates, e.g., a ceramic filler or a silicate glass bead filler (e.g., “microballoons”), in any amount that allows for mechanical properties as described herein, as well as dimensional stability. Exemplary inert fillers may include inorganic powders that can provide a rigid polyurethane having desired dimensional stability, or mechanical properties as described herein. Such particles are known, and may have a size in the range of less than about 200 μm, less than 50 μm, or less than 10 μm, and may be materials such as calcium carbonate, silica, aluminum hydroxide, alumina, fly ash, ceramic powder, glass beads, hollow microspheres, and the like.

Rigid polyurethane foams materials are known in the polyurethane arts, and are described, for example, in the following patent documents, which are incorporated herein by reference for their description of polyurethane chemistry; rigid polyurethane materials and their properties and chemical compositions; ingredients and additives, and their respective useful amounts for preparing rigid polyurethane materials; and methods for preparing rigid polyurethane materials: US 2005/0052425 (U.S. Ser. No. 09/402,303 to Kaku et al.), and US 2003/0100623 (U.S. Ser. No. 10/148,225 to Kaku et al.).

Rigid polyurethane foams are commercially available, for example, from Industrial Polymers Incorporated, of Houston Tex. Examples of rigid polyurethane materials that have been found to be particularly useful for decoys and decoy portions according to the invention, include materials marketed commercially by Industrial Polymers Incorporated, under the trade names Polystone™ and Polywood™. As will be understood based on the present description, other rigid polyurethane materials that have mechanical or chemical properties similar to those of Polystone™ and Polywood™, will be useful as well in preparing decoys and decoy portions as described herein.

According to preferred constructions, a decoy body, head, other portion, or an complete decoy (head, body, tail, optional ballast) can be a hollow shell made of rigid polyurethane. A hollow rigid polyurethane decoy head may be produced, and assembled by attachment to a decoy body made of any material, such as rigid polyurethane, cork, wood, foam, etc. Alternately, an entire decoy may be prepared as a hollow shell shaped in the form of a complete waterfowl.

A hollow decoy or decoy portion in the form of a shell of rigid polyurethane may be partially or completely filled, if desired, with another material such as a foam. The foam may be inserted into the hollow interior space of the shell after the rigid polyurethane shell is first formed or molded, or, the rigid polyurethane shell may be formed around a foam piece.

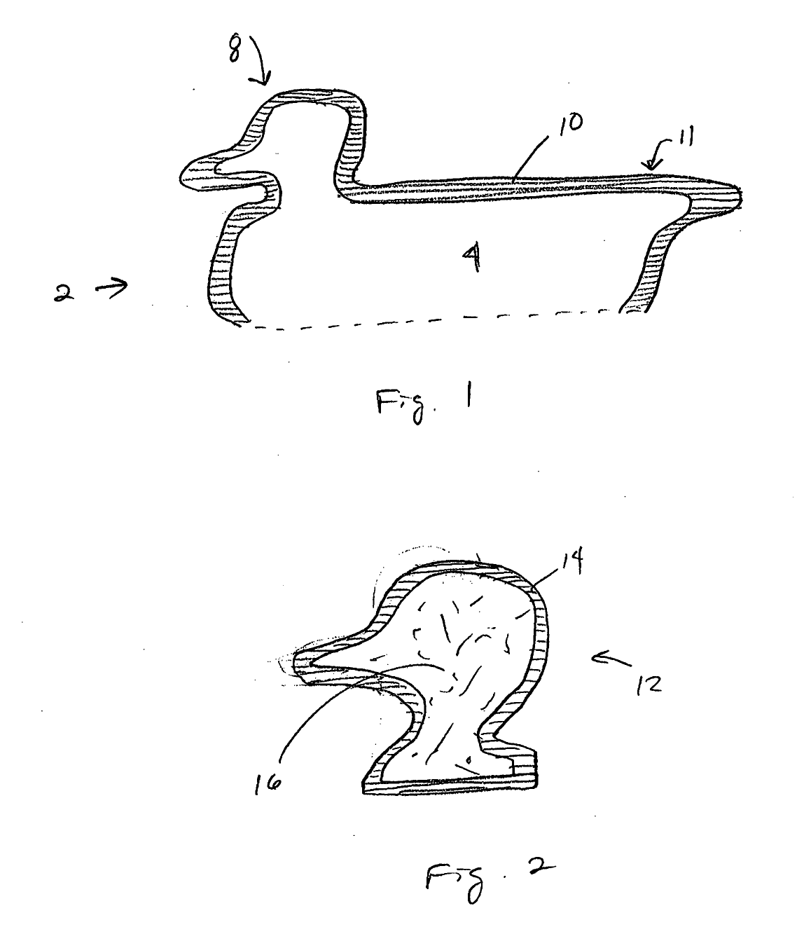

Referring to FIG. 1, decoy 2 is shown to include interior 4, and head 8 and body 11 defined by shell 10. An exemplary decoy according to the invention includes hollow shell 10 made of rigid polyurethane. The thickness of rigid polyurethane shell 10 may be as desired to provide strength and durability properties as discussed. Interior 4 is illustrated in FIG. 1 to be hollow and empty, but alternate embodiments may include an interior that is partially or entirely filled with a solid material such as buoyant foam, wood, cork, or a similar material.

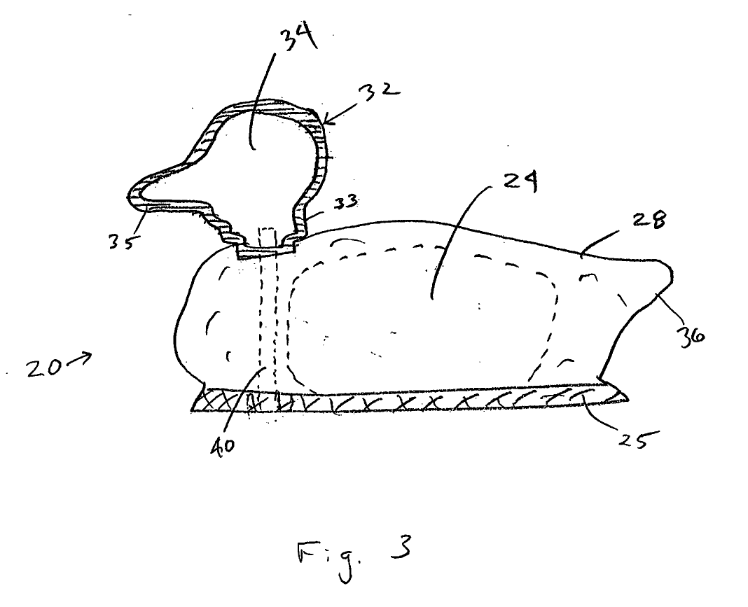

FIG. 2 shows an example of another decoy portion of the invention. Decoy head 12 is a portion of a complete decoy, and is constructed of foam interior 16 surrounded by shell 14 of rigid polyurethane.

A rigid polyurethane decoy head as described herein may be useful with other decoy pieces that can be but are not required to be made of rigid polyurethane. For example, a decoy head 12 may be secured to a decoy body that is made of any useful material such as a buoyant material, e.g., a cellular polymeric material, including open-cell polymeric foam materials, closed cell polymeric foam materials, cellular thermosetting and thermoplastic materials; wood; cork (either high-density cork or low-density cork); and other materials such as buoyant materials known to be useful for waterfowl or other types of decoys.

A rigid polyurethane for use as decoy portions according to the present description, or a precursor liquid material, may include a rigid polyurethane polymer and may additionally include additives such as fillers, pigments or other coloring agents, plasticizers, surfactants, flow agents, molecular scavengers to inhibit moisture contamination, anti-oxidants to reduce oxidation, anti-foaming agents, etc. Exemplary and preferred polymeric compositions useful for molding decoys or decoy portions can include reduced amounts of organic solvent and water (e.g., less than 5 percent organic solvents or water).

A rigid polyurethane may be derived from a liquid (flowable) polymeric precursor composition, which may be of any form and composition capable of producing a hardened rigid polyurethane decoy or decoy portion as described. A liquid polymeric composition may be solventless (100 percent solvent), water-based, solvent-based, curable, thermoplastic, thermosetting, etc., such as a one-part or two-part liquid polymeric composition that can be molded or otherwise formed (e.g., carved) to form a decoy or a decoy portion.

The use of rigid polyurethane as a decoy or decoy portion has been found to provide for very desirable mechanical properties for use in a game decoy such as one or more of good durability, prevention of breakage of extended portions of a decoy, and prevention of a loss of buoyancy in the event that a decoy should be accidentally hit by shotgun fire.

To prepare a decoy or decoy portion, a liquid precursor to a rigid polyurethane may be poured or otherwise provided into a mold and then the material can chemically or thermally cured or otherwise harden, for example by chemical action that includes crosslinking or polymerization, e.g., reaction of an isocyanate group with an alcohol or amine to produce a polyurethane. Desired properties of the liquid precursor material can include flow properties that allow for pouring the liquid material into a mold, convenient demolding time, and desirable properties of the hardened rigid polyurethane such as hardening to a tack-free, paintable, cured material. Decoy portions made by molding a rigid polyurethane have also been found to exhibit a high level of structural, surface detail passed between a mold and a cast or molded decoy portion.

The rigid polyurethane upon curing or hardening can preferably exhibit one or more of: mechanical hardness (without being unduly brittle), resistance to water over prolonged exposure, low porosity, mechanical properties such as low elongation, high tensile strength, and density within a desired range. Mechanical hardness can allow a decoy or decoy portion to withstand impact between decoys when decoys are handled and avoid breakage of extended portions of a decoy such as a neck, head, bill, or tail.

Depending on the thickness of a hardened rigid urethane shell, a decoy or decoy portion may be sufficiently thick and mechanically tough to withstand shotgun fire, preferably without penetration through the shell. A thickness of from ¼ to ½ inch has been found to exhibit good resistance to shotgun fire at as little as 25 yards. Optionally, a rigid urethane shell can include an interior that further strengthens the shell, such as a foam, cork, or wood, which can improve durability, toughness, or resistance to shotgun fire of the decoy or decoy portion.

Exemplary rigid polyurethane materials that will be useful according to the invention are commercially available, for example, from Industrial Polymers Incorporated, of Houston Tex. Examples of rigid polyurethane materials that have been found to be particularly useful for decoys and decoy portions according to the invention, include materials marketed commercially by Industrial Polymers Incorporated, under the trade names Polystone™ and Polywood™. As will be understood based on the present description, other rigid polyurethane materials that have mechanical or chemical properties similar to those of Polystone™ and Polywood™, will be useful as well in preparing decoys and decoy portions as described herein. These materials are polymeric rigid polyurethanes that can be made from a liquid precursor of a two-part liquid system. The liquid precursor can be formed from the two liquids and cured to any desired shape. The liquid may be formed by molding, carving, etc.

Preferred rigid polyurethane precursor materials can take the form of an uncured combination of two liquid parts that can be combined and formed into a decoy portion, and cured or hardened (either before or after forming). After mixing to form the precursor, the chemical ingredients of the two pars react to cause the precursor to harden to result in a decoy portion having desirable mechanical properties. The two-part liquid composition can include low levels of organic solvent, e.g., may be 100 percent solids, and may cure to form a hardened elastomeric polyurethane or polyurea. Generally, one liquid part will include polyol (e.g., triol) and no polyisocyanate, and the other liquid part will include polyisocyanate (e.g., MDI) and no polyol.

A liquid part that contains polyol may contain any amount, such as from 50 to 90 percent polyol by weight of the composition, and may include inert filler in a useful amount, such as from 10 to 50 percent by weight, e.g., from 10 to 30 percent by weight.

A liquid part that contains polyisocyanate (e.g., MDI) may contain a mixture of polyisocyanate monomer (e.g., from 10 to 50 percent monomer by weight) and higher oligomer of MDI (e.g., from 40 to 60 percent oligomer by weight).

Preferably, a hardened rigid polyurethane may be capable of being painted, meaning that a latex or oil-based paint may be applied to a rigid polyurethane surface and will adhere to the hardened rigid polyurethane surface to produce a durable painted decoy or decoy portion.

A decoy portion in the form of a hollow shell can be prepared by any desired method, such as by casting (e.g., molding) and then carving, by molding to directly form a decoy portion, by carving from a large piece or block of rigid polyurethane material, or by any combination of these or other useful methods. A desirable mold may be any useful type of mold such as a mold of silicone, plaster, polyurethane, aluminum, wood, etc., and useful molding techniques may be of the types referred to as spin-molding, roto-molding, insert molding, blow molding, injection molding, etc. Useful molds and molding equipment for casting decoys and decoy portions as described herein will be known and are commercially available.

As an example of a method of preparing a decoy or decoy portion, a shape of an animals or animal portion such as a duck, duck head, etc., can be formed (e.g., carved) and a mold may be produced from that piece, e.g., a mold of plaster, silicone, aluminum, urethane, etc., by any method of producing a mold. That mold may be used directly to form a decoy portion or decoy according to the invention, from rigid polyurethane.

As a variation on this method, the size of the decoy or decoy portion can be scaled up by using the mold to prepare pieces from a water-expanding urethane such as the type that is available from Industrial Polymers Inc., under the trade name Hydrospan™. The water-expanding urethane may be expanded, and then a larger mold may be made from the larger-size shape. By this series of steps, a small animal piece or portion may be used to produce a larger decoy or decoy portion.

A decoy portion (e.g., entire decoy body, decoy head, etc.) may be of any size, and shape useful to attract game. Useful shapes for a duck decoy in particular can be of a duck of any of various breeds and sizes, while other decoys may be of various animals such as wild turkey, a goose, a non-bird animal, etc. The decoy may optionally be assembled from two or more pieces such as a head, neck, multiple body pieces, a single main body piece, a tail piece, etc., any of which may be of a rigid polyurethane material as described, or of another decoy material. According to general decoy embodiments, a decoy body may include a hollow center, which may reduce weight and improve buoyancy. A hollow interior space may be achieved by any method, such as by molding to produce a hollow interior; by producing a solid interior and carving a center of a decoy (of a rigid polyurethane or other material); or by assembling a decoy from multiple pieces, such as multiple horizontal strata, with one or more horizontal strata of an assembly including a hollow interior to produce a closed hollow interior of the decoy. The size may be actual size of a duck, goose, or turkey, or an enlarged size.

An example of a duck decoy may have a duck shape made from pieces that include a headpiece comprising rigid polyurethane shell (solid or hollow and if hollow, optionally including foam that completely or partially fills the interior) secured to and a body that is of rigid polyurethane (hollow, solid, or partially or completely filled, etc.) or another material such as cork, wood, another type of foam (e.g., Styrofoam), etc. The headpiece may be secured to a body by any securement mechanism, such as a nut and bolt extending from the head down through an aperture in the one or more body pieces. Alternately, pieces of a decoy may be adhered together by adhesive, such as a water-based wood glue, for example Elmer's ™ wood glue, or any other glue that is effective to secure the pieces for normal decoy use.

A decoy body may have any combination of dimensions measured at maximum distances of length, width, and height (not including the head, tail, or a keel, if any), such as for a duck decoy: about 15″ (inches)×7″×5″; alternately 17″×11″×7″; alternately 23″×13″×7″. Larger or smaller dimensions may be useful depending on the game animal and breed and depending on if the scale is approximately lifesize or greater than lifesize.

Exemplary decoy portions or bodies that are made from non-rigid-polyurethane, may be of high or low density cork; wood; any form of open-cell or closed-cell polymeric foam such as Styrofoam, polyurethane, high-density polyurethane, etc., as are useful with game decoys. The decoy may optionally include a weighted keel. Also optionally, a decoy may include added features such as an attachment for a line or anchor, or a mechanical feature such as a motor for propulsion or moveable wings.

Extensions of a decoy such as legs, tail, and the neck, head, or bill, may exhibit relatively greater fragility relative to the main body portion (i.e., back, sides, and front below the head). This can be especially true of foam decoys that are constructed by assembly of two separate pieces including a main body piece and a replaceable headpiece. To improve durability of a relatively fragile portion such as a bill, neck, tail, or a connection or seam between a neck and a body, the decoy or decoy portion may be made of rigid polyurethane as described herein, and may be of a thickness to provide desired mechanical toughness and durability. Exemplary thickness of a rigid polyurethane material such as a Polywood™ or a Polystone™ decoy shell may be up to a half inch, e.g., from ¼ to ½ inch thick. This thickness may provide good mechanical properties for a decoy portion, such as resistance to shotgun fire, strength, and durability during normal handling.

An exemplary decoy design having rigid polyurethane head, and a body of another decoy material, is shown at FIG. 3. Decoy 20 includes buoyant main body piece 28 having hollow center 24 and replaceable headpiece 32. Main body piece 28 can be of a buoyant decoy material such as wood, a cork, a foam such as Styrofoam or a polyurethane, etc. Headpiece 32 is a separate (e.g., replaceable) decoy portion that includes neck 33, bill 35, and hollow interior 34, which may be either empty or optionally may be filled, such as with a foam, completely or partially. For example, while not illustrated as filled, bill 35 may be preferentially filled with foam or another buoyant material to reinforce bill 35 from breakage upon contact. Filling the entire head with foam or another buoyant material may improve other mechanical properties such as resistance to shotgun fire. Headpiece 32 connects to main body 28 through neck 33. Bolt and nut assembly 40 secures headpiece 32 to main body piece 28. Main body piece 28 includes hollow center 24 and tail 36. Decoys of the type that include a main body piece 28 (hollow or otherwise) and a separate replaceable (non-rigid-polyurethane) headpiece 32, in Styrofoam or cork, are commercially available from suppliers such as Cabela's, of Oshkosh, Nebr. Removable headpiece 32 is designed to be replaceable if the head of the decoy becomes damaged or broken off during use.

Decoy 20 further includes optional bottom piece 25 with an optional keel, bottom piece 25 being in contact with the underside of main body piece 28. Bottom piece 25 contacts the bottom perimeter surface of main body piece 28 and partially defines hollow center 24. Bottom piece 25 can be secured to main body 28 by mechanical fastener or by adhesive, or the like.

FIG. 3 shows a duck decoy, but other decoys of the invention can be shaped to mimic other game animals such as turkey, geese, etc. Turkey and geese decoys may also be assembled from multiple pieces such as a main body piece, a separate tail piece (not shown in the duck of FIG. 3), a headpiece, a longer neck for a goose, etc.

For strength testing, decoy portions in the form of duck heads were prepared from Polystone™ and Polywood™ materials by using a molding process to place a rigid polyurethane shell at the outside of a foam duck head. A mold was prepared to have a cavity in the form of a duck head. A foam head insert was prepared to have a size slightly smaller than the size of the mold cavity. The foam head was placed in a mold (to leave space between the surface of the head and the surface of the cavity) and liquid polyurethane material (Polystone™, Polywood™) was used to fill the space between the foam duck head and the mold cavity surface. The polyurethane was allowed to cure to form a rigid polyurethane shell around the foam head piece, the shell having a thickness in the range from 0.25 to 0.5 inches.

For testing resistance to shotgun fire a duck head was placed on land and a 12-gauge shotgun was fired at the head from approximately 25 yards. The shotgun barrel was 30 inches in length with a full choke. Shells used were 3-inch, number 4 shot having a muzzle velocity of approximately 1400 feet per second. The form and shape of the decoy heads were relatively unharmed, and the shot did not penetrate the heads having a rigid polyurethane shell of at least ¼ inch.

For additional durability testing duck heads were placed on duck decoy bodies and the decoys were dropped vertically from heights of at least 3, 4, or 5 feet to hit solid ground with impact to the head or bill, without breaking.

1. A game decoy comprising a decoy body mimicking a shape of a game animal, the decoy comprising rigid polyurethane having a specific gravity in the range from 0.5 to 0.9, wherein the rigid polyurethane comprises inert filler.

2. The decoy of claim 1 wherein the rigid polyurethane is a closed cell rigid polyurethane foam comprising crosslinked polyurethane and silicate glass beads.

3. The decoy of claim 1 wherein the rigid polyurethane comprises polyurethane and ceramic filler.

4. The decoy of claim 1 comprising a decoy body and head that comprise a hollow shell of molded rigid polyurethane.

5. The decoy of claim 1 comprising
a body comprising a material selected from the group consisting of cork, a polymeric foam, and wood, and
a head comprising a rigid polyurethane shell having a thickness in the range from 0.25 to 0.5 inches.

6. (canceled)

7. The decoy of claim 1 wherein the rigid polyurethane exhibits a mechanical property selected from the group consisting of:

| | |
|---|---|
| elongation (ASTM D 638) | less than 2 percent, |
| Shore D hardness (ASTM D 638) | from 50 to 70[[,]] |
| | and any combination thereof. |

8. The decoy of claim 1 wherein the rigid polyurethane exhibits a mechanical property selected from the group consisting of:

| | |
|---|---|
| Tensile strength (ASTM D 638) | 2500 to 4000 pounds per square |
| | inch, |
| Elongation (ASTM D 638) | from 0.5 to 1.5 percent, |
| Shore D hardness (ASTM D 638) | from 50 to 70, |
| | and any combination thereof. |

9. The decoy of claim 1 wherein the rigid polyurethane comprises
polymer derived from multi-functional isocyanate and polyol, and
ceramic filler.

10. The decoy of claim 9 wherein
the multifunctional isocyanate comprises 4,4′-diphenylmethane diisocyanate, and
the polyol comprises triol.

11. The decoy of claim 1 wherein the rigid polyurethane is prepared by molding the polyurethane to form a hollow decoy portion, the hollow decoy portion comprising a polyurethane shell having a thickness in the range from 0.25 to 0.5 inch.

12. The decoy of claim 1 wherein the game decoy comprises a decoy or decoy portion selected from the group consisting of:
a decoy shell comprising an integral head and body,
a shell of a decoy head, and
a shell of a decoy body,
wherein any one of these is hollow and empty, is partially filled with a buoyant material, or is completely filled with a buoyant material.

13-20. (canceled)

21. A game decoy according to claim 1, comprising a decoy body mimicking a shape of a game animal, the decoy comprising rigid polyurethane that exhibits mechanical properties that include:

| | |
|---|---|
| elongation (ASTM D 638) | less than 2 percent[[,]] and |
| Shore D hardness (ASTM D 638) | from 50 to 70, |

22. The decoy of claim 21 wherein the rigid polyurethane exhibits mechanical properties that include:

| | |
|---|---|
| Tensile strength (ASTM D 638) | 2500 to 4000 pounds per square |
| | inch[[,]] |

23. A game decoy comprising a decoy body mimicking a shape of a game animal, the decoy comprising a cured rigid polyurethane foam shell, the polyurethane foam having a specific gravity in the range from 0.5 to 0.9, wherein the game decoy comprises a decoy or decoy portion selected from the group consisting of:
a decoy shell comprising an integral head and body.
a shell of a decoy head, and
a shell of a decoy body,
wherein any one of these is partially filled with a buoyant material, or is completely filled with a buoyant material.

24. (canceled)

25. The decoy of claim 23 wherein the rigid polyurethane comprises
polymer derived from multi-functional isocyanate and polyol, and
ceramic filler.

26. The decoy of claim 25 wherein
the multifunctional isocyanate comprises 4,4′-diphenylmethane diisocyanate,
the polyol comprises triol, and
the ceramic filler comprises silicate glass beads.

27. The decoy of claim 23 wherein the rigid polyurethane is prepared by molding the polyurethane to form a hollow decoy portion, the hollow decoy portion comprising a polyurethane shell having a thickness in the range from 0.25 to 0.5 inch.

28. The decoy of claim 23 wherein the decoy shell is at least ¼ inch thick and can withstand 12-gauge shotgun fire from 25 yards without shot penetration, using number 4 shot at a muzzle velocity of 1400 feet per second.

29. The decoy of claim 28 wherein the shell is filled or partially filled with buoyant material.

30. A game decoy comprising a decoy body mimicking a shape of a game animal, the decoy comprising rigid polyurethane having a specific gravity in the range from 0.5 to 0.9, wherein the rigid polyurethane comprises
polymer derived from multi-functional isocyanate and polyol, and
ceramic filler.

31. A game decoy comprising a decoy body mimicking a shape of a game animal, the decoy comprising a cured rigid polyurethane foam shell, the polyurethane foam having a specific gravity in the range from 0.5 to 0.9, the polyurethane comprising polymer derived from multi-functional isocyanate and polyol, and ceramic filler.

32. A game decoy comprising a decoy body mimicking a shape of a game animal, the decoy comprising a cured rigid polyurethane foam shell, the polyurethane foam having a specific gravity in the range from 0.5 to 0.9, wherein the decoy shell is at least ¼ inch thick and can withstand 12-gauge shotgun fire from 25 yards without shot penetration, using number 4 shot at a muzzle velocity of 1400 feet per second, and wherein the shell is filled or partially filled with buoyant material.
